(19) United States
(12) Patent Application Publication
(10) Pub. No.: US 2012/0290425 A1
(43) Pub. Date: Nov. 15, 2012

(54) Charity payment system and process

(76) Inventor: Julie Aaron, New York, NY (US)

(21) Appl. No.: 13/467,598

(22) Filed: May 9, 2012

Related U.S. Application Data
(60) Provisional application No. 61/484,069, filed on May 9, 2011.

(51) Int. Cl. G06Q 30/06

(52) U.S. Cl. 705/26.1

(57) ABSTRACT

An Internet-based system and computer implemented method for facilitating a charitable donation from a donor in connection with the purchase of a good or service. The system including a website coupled to a website server. At least one charity is identified on the website designated to be selected by a donor to receive at least a portion of proceeds received from a sale of a good or service. An inventory of goods or services is available for purchase through the website wherein a portion of the proceeds from a portion of purchased goods or services is provided to at least one charity. A purchase tool is provided for executing a purchase of a good or service such that a portion of the proceeds from a portion of purchased goods or services is provided to a charity.

### FIELD OF THE INVENTION

The invention relates to a system and process for enabling merchants and individuals to sell goods and/or services on behalf of a charity.

### BACKGROUND OF THE INVENTION

The internet retail market has recently experienced amazing growth and is expected to continue its expansion. It is predicted e-commerce industry will continue to grow annually for the foreseeable future.

The internet retail market has opened new channels for charitable giving. According to recent reports, nonprofit online fundraising increased by 19% from 2006 to 2007. The power of reaching millions of users cannot be underestimated. For instance, in 2000, Warren Buffet began donating a lunch with himself to the Glide'Foundation, a charity in San Francisco. Four years later, this annual event was auctioned on eBay demonstrating the opportunity and growth of online charitable giving is significant.

However, it is noted supporting a charity is currently inconvenient as it still relies on outdated techniques. This is principally because organizations still fundraise in essentially the same way based on past precedent—they ask for it. Thus a need exist to provide new techniques for raising charitable funds.

### SUMMARY OF THE INVENTION

The present invention is their directed to a system and process configured and operative to enable buyers to make the same purchases they normally would wherein buyers can support chosen cause without impacting their own bottom line. It is to be understood and appreciated, the present invention charity payment system and process may become ubiquitous by integrating into social networking sites, merchants' shopping carts and charities' homepages.

It is further to be understood and appreciated that while traditional forms of charity require substantial commitments of time or money, the present invention charity payment system and process enables individuals to contribute by purchasing items they were predisposed to purchase. Individuals and merchants can donate goods and services to the present invention charity payment system and process which, in turn, will be sold with a portion of the purchase price going to charity.

The present invention charity payment system and process obviates the need for buyers/donors from having to go to designated charitable site locations as the present invention charity payment system and process preferably directly integrates with established merchants such that buyers can choose a designated payment process for making a donation in return for merchant goods/services. For instance, the Gap™ integrates with the present invention charity payment system and process so as incorporate a designated payment button to their site. The inclusion of this designated “payment button” designates which merchant products/services benefits a charity, essentially donating the retail profit. Thus, when a seller enables this option for goods/services, the seller and/or buyer can select which charity will benefit from the sales of such goods/services. After payment is cleared, the present invention charity payment system may retain a portion of the net profit from those items designated by the seller with the remaining portion going directly to charity.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a system level diagram of a computering system used with the present invention in accordance with the illustrated embodiments; and

FIGS. 2A and 2B are system and flow diagrams depicting an illustrated embodiment of the present invention.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

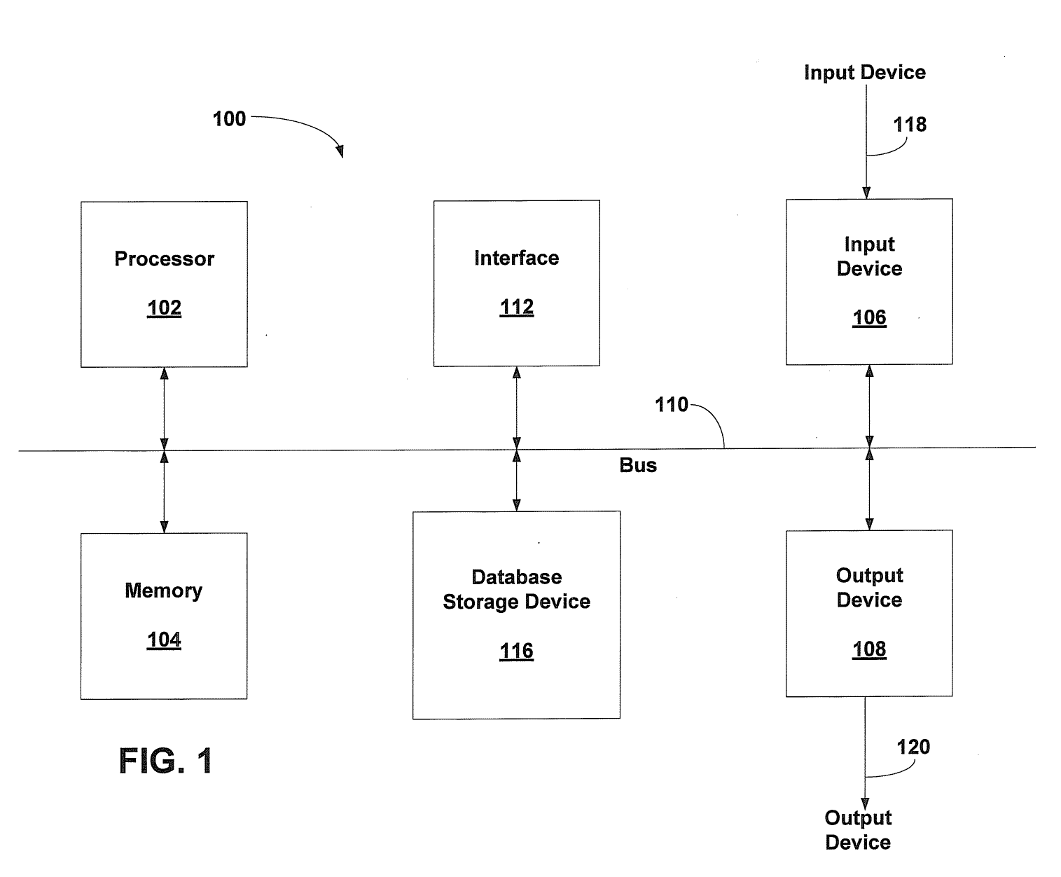

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

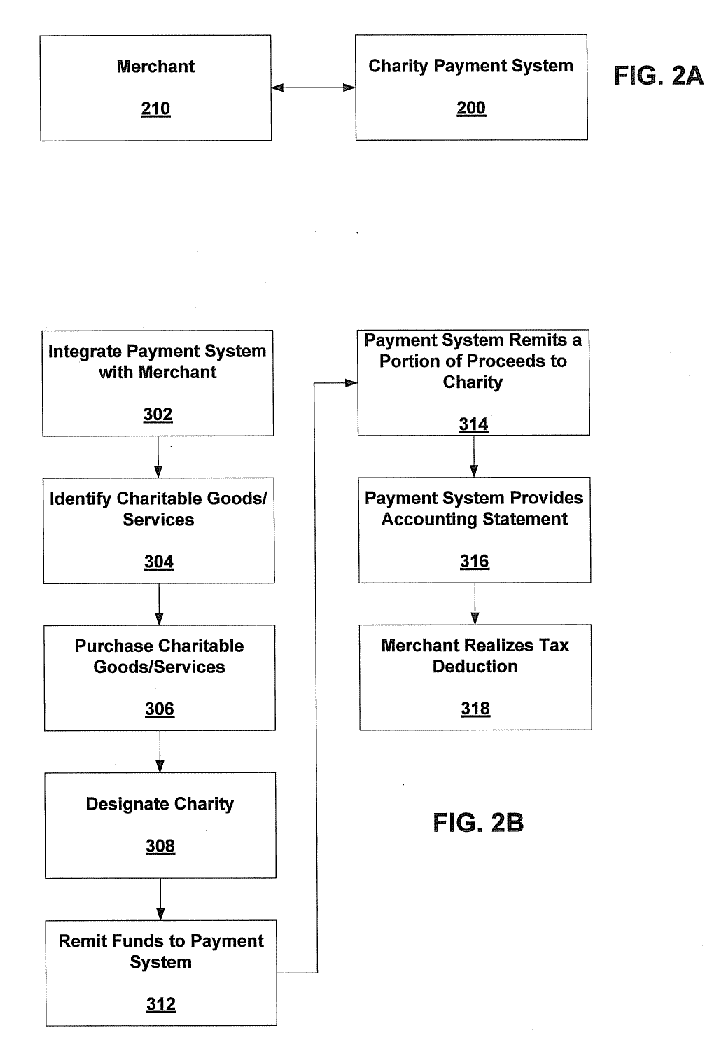

With the exemplary computing system environment 100 of FIG. 1 being generally shown and discussed above, discussion will now turn to the present invention system and process for donating the proceeds from the sale of goods/services to charity which utilizes system 100, or components thereof. With reference to FIGS. 2A and 2B, designated generally by reference numeral 200, is the present invention charity payment system electronically linked to an existing retail merchant (designated generally by reference numeral 210)(step 302). As discussed below, charity payment system 200 utilizes components of above described computer system 100 and is configured and operative to enable a retail merchant 210 to designate the proceeds received from the sale of goods/services to be donated to a user selected charity wherein system 200 consummates the sale of such goods/services and provides at least a portion of the sale proceeds to a designated charity. It is to be understood and appreciated by one skilled in the art that system 200 integrates with a merchant 210 similar to how PayPal™ or Google™ Checkout integrates with a merchant 210 as a payment system.

It is further to be appreciated that while system 200 is illustrated in conjunction with a merchant system 210, system 200 is not to be limited thereto as it may be integrated with any service compatible with the intended charitable services of system 200, such as for example a social networking site (e.g., Facebook) or a charity homepage, and the like.

Once payment system 200 is integrated with merchant 210, the merchant preferably designates which goods/services offered are to be associated with charity payment system 200 (step 304). It is to be appreciated the designation of which goods/services are to be associated with charity payment system 200 may be accomplished in a number of ways. For instance, a virtual room or web page may be created on the merchant website 210 which identifies all such goods/services. Alternatively, when a buyer selects such good/services for purchase, the buyer is presented with the option to pay the merchant for the goods (e.g., using traditional payment systems) and/or the buyer is presented the option to pay for such goods/services using payment system 200 wherein at least a portion of the sale proceeds are directed to charity as opposed to the merchant 210, as further explained below.

When a buyer decides to purchase goods/services from a merchant 210 that are designated to be sold through the charity payment system 200, the buyer simply purchases the goods/services by selecting charity payment system 200 as preferably indicated in conjunction with the goods/services (e.g., similar to a PayPal™ purchase process) (step 306). The payment process is then accomplished via the charity payment system 200. It is to be understood and appreciated, charity payment system 200 may be configured and operative to enable a buyer to select or designate a charity which is the receive the charitable donation via the purchase of the aforesaid merchant goods/services (step 308). For instance, charity payment system 200 may be configured to indicate one or more charities which my be selected by the buyer. Additionally, charity payment system 200 may be configured such that a buyer can select multiple charities wherein the sales revenue is apportioned amongst the selected charities. Still further, a buyer may input a charitable organization of their own choosing to be used by system 200.

Next, payment system 200 causes the designated funds to be remitted from a buyers designated financial account (e.g., credit card, checking/banking account, ACH, PayPal account and the like) to payment system 200 (step 312). At least a portion of the aforesaid received designated funds are apportioned and forwarded to the designated charities by system 200 using any appropriate means for doing so (step 314). It is noted system 200 may be configured and operative to retain a designated amount (e.g., 25%) of the proceeds for either profit and/or non-profit purposes.

Additionally, charity payment system 200 may be configured and operative to provide the merchant 210 with an accounting statement indicating all merchant goods/services sold by system 200 and the amount of charity donations made to each designated charity (step 316). The merchant 210 may then use this accounting statement for tax deduction purposes.

Accordingly, exemplary advantages of the present invention charity payment system and process in accordance with the illustrated embodiments include:
In contrast to known prior art processes which are based on two party transactions (whether between a donor and a charity, or a charity and a purchaser), the present invention integrates all three parties (e.g., donor, charity and purchaser) to the transaction, making a seamless connection between the parties satisfying the different objectives of each party;
Buyers are made aware that a portion of the purchase price for selected goods/services are donated to a charity;
The charity payment system 200 is integrated with a merchant website 210;
Buyers benefit from a constant and dynamic offering of merchant goods/services;
In other embodiments of the present invention, individual sellers are enabled to post items for charitable sale, providing another incentive to visit a website frequently;
Buyers may have the option to buy goods at discounted prices;
Charities may be required to use the funds raised for specific studies and projects, and are required to indicate how the finds were used and the undertaking results—provides a level of accountability demonstrating the impact of the project(s).
Merchants/sellers contribute to a selected charity or project obviating the requirement for a monetary donation; and
Provides tax benefits for merchants/sellers.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention charity payment system and process, and of the manner and process of making and using them, in such full, clear, concise, and exact terms as to enable any person skilled in the art to which it pertains to make and use these devices and methods. The present invention charity payment system and process is, however, susceptible to modifications and alternative method steps from those discussed above that are fully equivalent. Consequently, the present invention charity payment system and process is not limited to the particular embodiments disclosed. On the contrary, the present invention charity payment system and process encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A computer implemented method for electronically donating proceeds to a selected charity comprising the steps of:
identifying a charity to receive at least a portion of proceeds received from a sale of goods;
identifying goods to be purchased which are linked to said identified charity; and
purchasing said identified goods wherein a portion of the proceeds for purchasing said identified goods is automatically provided to said identified charity.

2. A computer implemented method as recited in claim 1 wherein a plurality of charities are provided to be identified by a user.

3. A computer implemented method as recited in claim 1 wherein a user can input a charity to receive at least a portion of proceeds received from a sale of goods.

4. A computer implemented method as recited in claim 1 wherein a user can identify a plurality of charities each to receive at least a portion of proceeds received from a sale of goods.

5. A computer implemented method as recited in claim 4 wherein a user prescribes an amount of the proceeds to be provided to each of said identified plurality of charities.

6. A computer implemented method as recited in claim 1 wherein a plurality of goods to be purchased by a user are provided wherein only a subset of said plurality of goods to be purchased are linked to a said identified charity.

7. A computer implemented method as recited in claim 1 wherein said goods to be purchased include services to be purchased.

8. A computer implemented method as recited in claim 1 wherein said computer implemented method for electronically donating proceeds to a selected charity is integrated with a merchant system electronically offering goods to be purchased.

9. A computer implemented method as recited in claim 1 furthering including the step of providing a report of charitable proceeds to affected parties.

10. An Internet-based system for facilitating a charitable donation from a donor in connection with the purchase of a good or service, the system comprising:
a website coupled to a website server;
at least one charity identified on the website designated to be selected by a donor to receive at least a portion of proceeds received from a sale of a good or service;
an inventory of goods or services available for purchase through the website wherein a portion of the proceeds from a portion of purchased goods or services is provided to a said at least one charity; and
a purchase tool for executing a purchase of a donor selected good or service adapted and configured such that a portion of the proceeds from a portion of purchased goods or services is provided to a said at least one charity and wherein the purchase tool is accessible to the donor through the website.

11. An Internet-based system as recited in claim 10 further including an inventory search tool for searching an inventory of goods or services, the inventory search tool configured to identify a found good or service based on inventory search criteria provided to the website by the donor, the inventory search tool accessible to the donor through the website, the goods or services being available for purchase through the website.

12. An Internet-based system as recited in claim 11 further including a charity search tool configured to identify a found charity based on charity search criteria provided by the donor to the website, the charity search tool accessible to the donor through the website.

13. An Internet-based system as recited in claim 10 wherein a user can input a charity to be identified to receive at least a portion of proceeds received from a sale of goods.

14. An Internet-based system as recited in claim 10 wherein a user can identify a plurality of charities each to receive at least a portion of proceeds received from a sale of goods.

15. An Internet-based system as recited in claim 14 wherein a user prescribes an amount of the proceeds to be provided to each of said identified plurality of proceeds.

16. An Internet-based system as recited in claim 10 wherein a plurality of goods to be purchased by a user are provided wherein only a subset of said plurality of goods to be purchased are linked to a said identified charity.

17. An Internet-based system as recited in claim 10 wherein said goods to be purchased include services to be purchased.
